(19) United States
(12) Patent Application Publication
(10) Pub. No.: US 2015/0002996 A1
(43) Pub. Date: Jan. 1, 2015

(54) KEYBOARD ASSEMBLY

(71) Applicant: HON HAI PRECISION INDUSTRY CO., LTD., New Taipei (TW)

(72) Inventors: CHIA-MING CHANG, New Taipei (TW); YI-CHENG KUO, New Taipei (TW)

(21) Appl. No.: 14/314,836

(22) Filed: Jun. 25, 2014

(30) Foreign Application Priority Data
Jun. 28, 2013 (TW) 102123389

(51) Int. Cl. G06F 1/18

(52) U.S. Cl. CPC G06F 1/182
USPC 361/679.08

(57) ABSTRACT

Keyboard assembly includes a base, a keyboard, and a fixing structure. The base includes a main body, and the main body defines a recess portion. The keyboard is received in the recess portion, and a first magnet is located on the keyboard. The fixing structure includes a fixing piece engaged with the recess portion, a second magnet, and a third magnet. The second magnet and the third magnet are attached to the fixing piece. The fixing piece is movable relative to the recess portion between a first position and a second position. When the fixing piece is located in the first position, the first magnet and the second magnet are attracted with each other, to secure the keyboard to the recess portion. When the fixing piece is located in the second position, the first magnet and the second magnet repel each other, to disengage the keyboard form the recess portion.

### FIELD

The present disclosure relates to keyboard assemblies, and particularly to a keyboard assembly with a fixing structure for a keyboard.

### BACKGROUND

A typical personal computer includes a keyboard and a base. The keyboard may be attached to the base with screws. A tool, such as a screwdriver, may be used to fasten or unfasten the screws when the keyboard is assembled or disassembled.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a keyboard assembly.

FIG. 2 is similar to FIG. 1, but viewed from a different aspect.

FIG. 3 is a partially assembled view of a base and a fixing structure of FIG. 1.

FIG. 4 is an assembled view of the keyboard assembly of FIG. 1.

FIG. 5 is a cutaway, cross-sectional view of the keyboard assembly of FIG. 4, taken along the line V-V of FIG. 4, and a fixing piece is in a first position.

FIG. 6 is similar to FIG. 5, but the fixing piece is in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

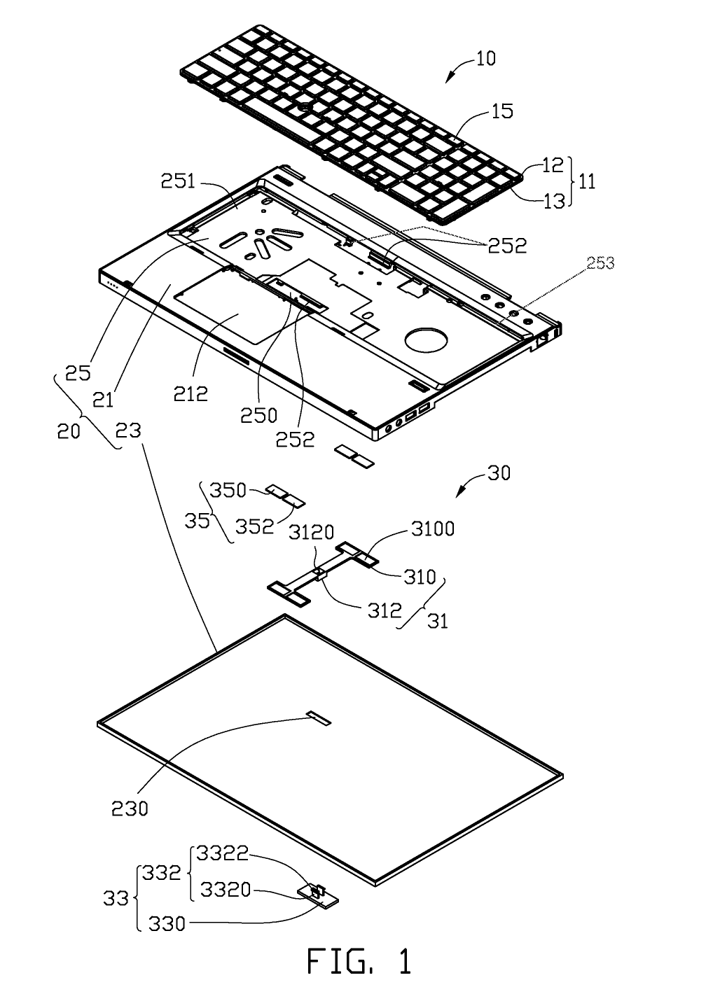

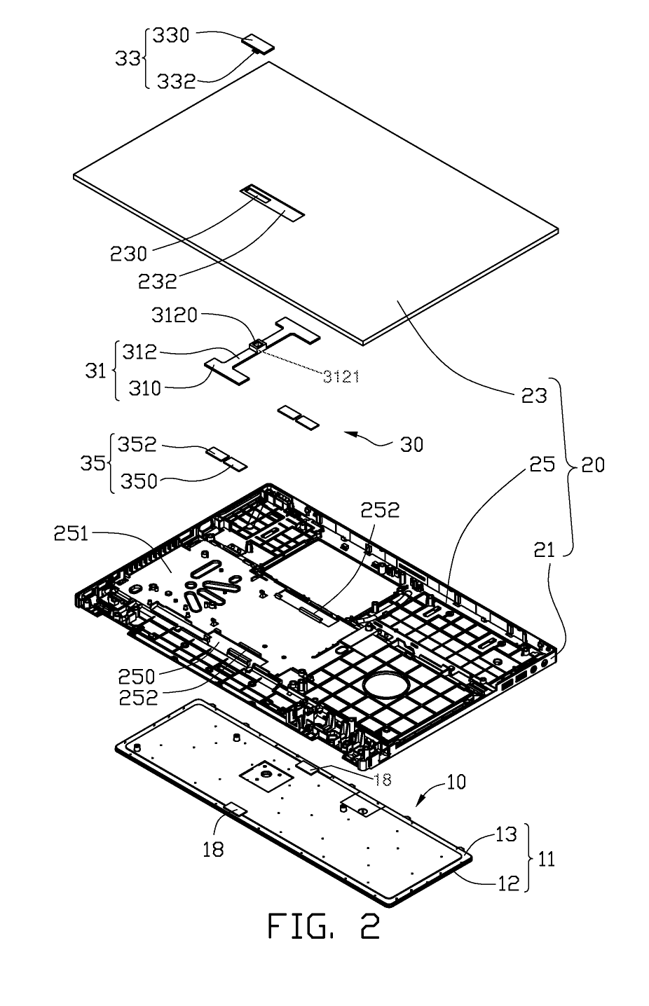

FIGS. 1 and 2 illustrate a keyboard assembly. The keyboard assembly includes a keyboard 10, a base 20, and a fixing structure 30. The fixing structure 30 can secure the keyboard 10 to the base 20.

The keyboard 10 includes a bottom board 11, a plurality of keys 15, and two first magnets 18. The bottom board 11 includes a top surface 12 and a bottom surface 13. The plurality of keys 15 are attached to the top surface 12. The two first magnets 18 are attached to the bottom surface 13 and positioned on a same line.

The base 20 includes a main body 21 and a bottom cover 23 secured to the main body 21. The main body 21 defines a recess portion 25 for receiving the keyboard 10 and an opening 212 in communication with the recess portion 25 for receiving a sensor module (not shown). The recess portion 25 includes a bottom wall 251 and two sidewalls 253. The two sidewalls 253 are connected to two opposite edges of the bottom wall 251, respectively. The bottom wall 251 defines two cutouts 250, and each of the two cutouts 250 extends to each of the two sidewalls 253. Two clipping hooks 252 extend from one edge of each of the two cutouts 250. In at least one embodiment, each of the two clipping hooks 252 is substantially “L”-shaped. The bottom cover 23 defines a receiving slot 232 in a bottom surface of the bottom cover 23, and a through hole 230 is defined in a bottom portion of the receiving slot 232.

The fixing structure 30 includes a fixing piece 31, an operation member 33, and two absorbing members 35. The fixing piece 31 includes two fixing tabs 310 and a connecting strip 312 connected to the two fixing tabs 310. Each of the two fixing tabs 310 defines two fixing slots 3100 corresponding to each of the two absorbing members 35. In at least one embodiment, the two fixing tabs 310 have a same plane with the connecting strip 312, and the plane is substantially parallel to the bottom wall 251 of the main body 21. A protrusion portion 3121 is located on the connecting strip 312 and defines a fixing hole 3120 extending through the connecting strip 312 corresponding to the operation member 33.

The operation member 33 includes a sliding piece 330 and two latching hooks 332 located on the sliding piece 330. The sliding piece 330 is parallel with the connecting strip 312 and can be received in the receiving slot 232. Each of the two latching hooks 332 includes a connecting piece 3320 connected to the sliding piece 330 and a latching tab 3322 extending from a distal end of the connecting piece 3320. An extension direction of the latching tab 3322 of one of the two latching hooks 332 is opposite to an extension direction of the latching tab 3322 of another of the two latching hooks 332. Each of the two absorbing members 35 includes a third magnet 350 and a second magnet 352. In one embodiment, the first magnet 18 and the second magnet 352 have different magnetic poles, and the first magnet 18 and the third magnet 350 have same magnetic poles.

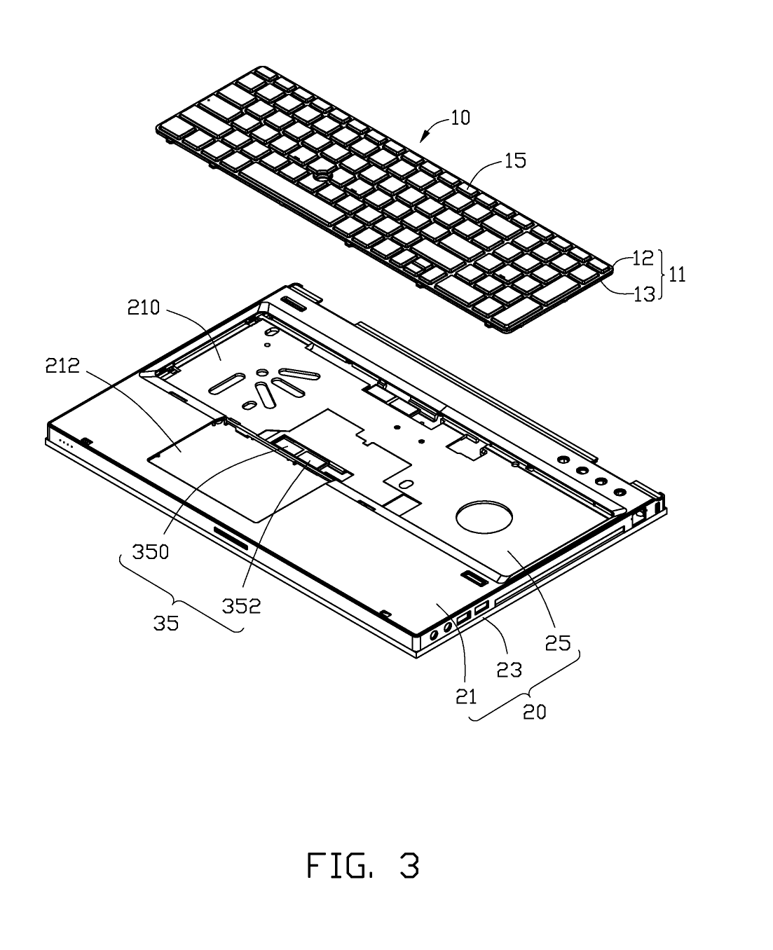

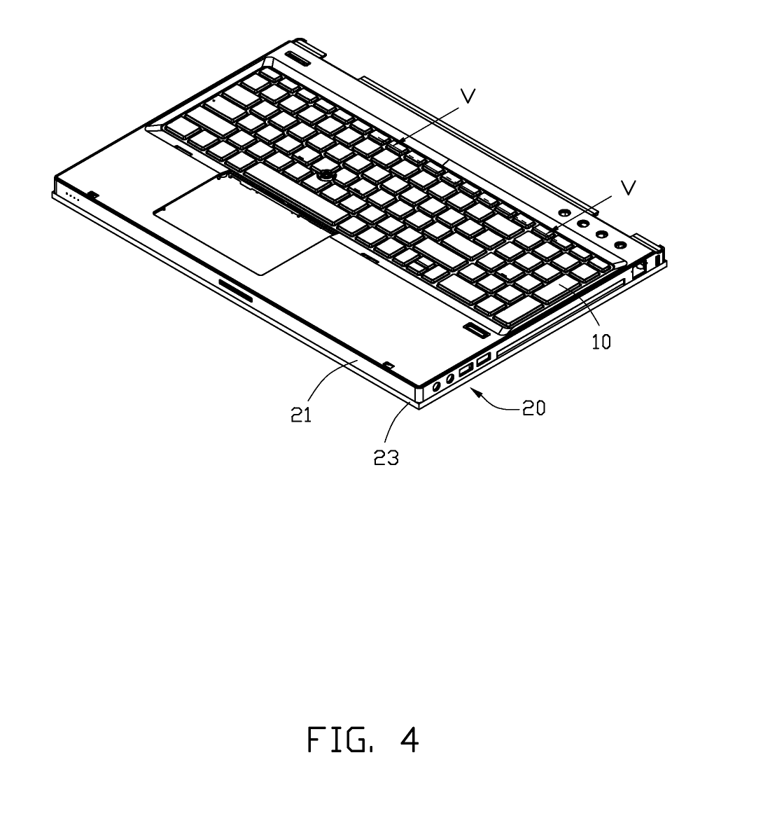

FIG. 3 and FIG. 4 illustrate that in assembly of the two absorbing members 35, the third magnet 350 and the second magnet 352 of one of the two absorbing members 35 are partially received in each of the two fixing slots 3100 of one of the two fixing tabs 310, and the third magnet 350 and the second magnet 352 of another of the two absorbing members 35 are partially received in each of the two fixing slots 3100 of another of the two fixing tabs 310. One of the two fixing tabs 310 is engaged with two clipping hooks 252, and another of the two fixing tabs 310 can be engaged with the other two clipping hooks 252 by resiliently driving corresponding clipping hooks 252. The connecting strip 312 abuts an outer surface of the bottom wall 351 of the recess portion 25, and each of the two absorbing members 35 is located in each of the two cutouts 250.

The bottom cover 23 is secured to the main body 21 and to the protrusion portion 3121 which is received in the through hole 230. The latching tabs 3322 of the two latching hooks 332 are inserted into the fixing hole 3120 to be engaged with edges of the fixing hole 3120. The sliding piece 330 is slidably received in the receiving slot 232 and abuts a first end of the receiving slot 232. The operation member 33 is thereby engaged with the fixing piece 31.

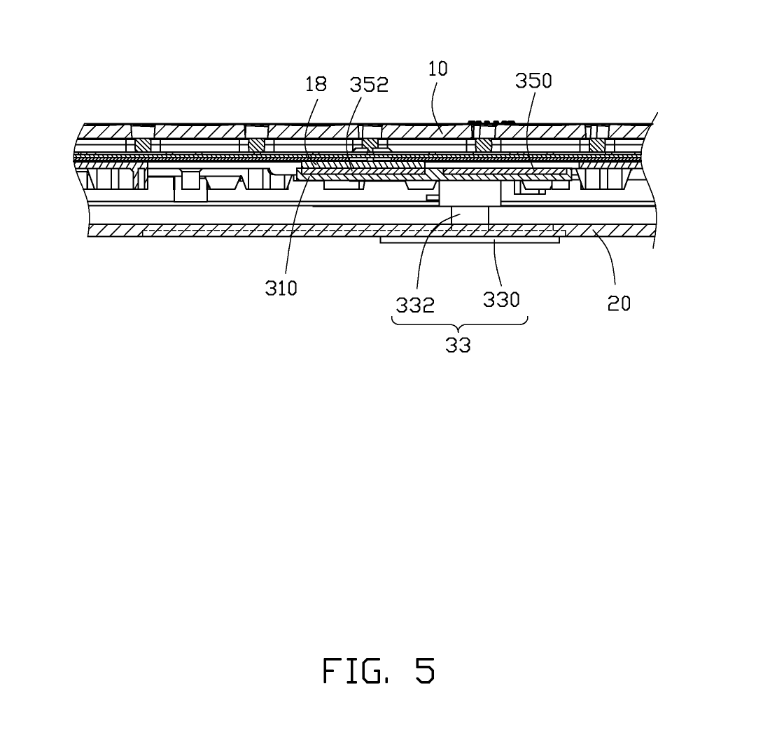

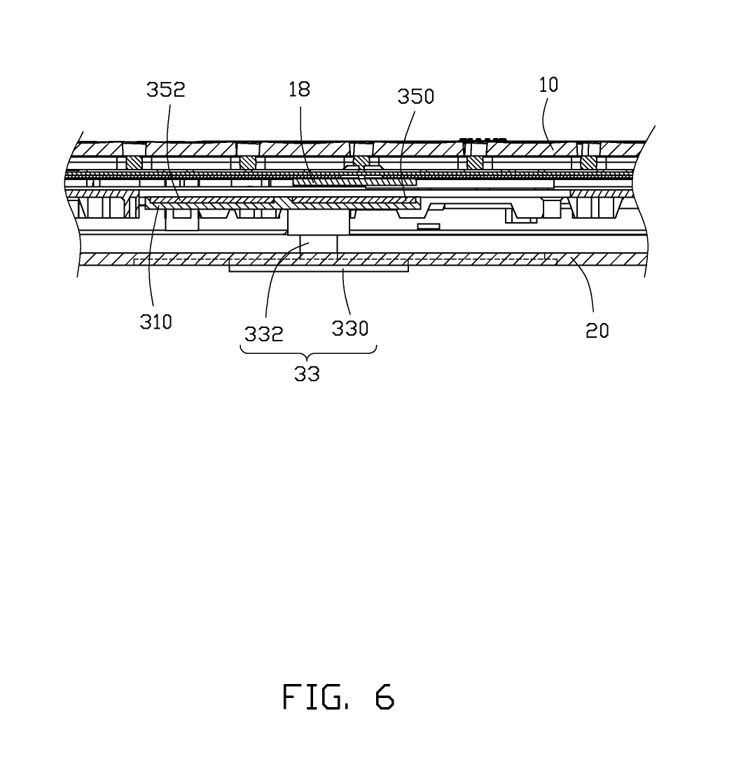

In assembly of the keyboard 10, the keyboard 10 is placed in the recess portion 25. The fixing piece 31 is movably driven by the operation member 33 between a first position (shown in FIG. 5) and a second position (shown in FIG. 6). In the first position, the second magnets 352 of the two absorbing members 35 are attracted with the two first magnets 18, to secure the keyboard 10 to the base 20. In the second position, the two third magnets 350 and the two first magnets 18 repel each other, to disengage the keyboard 10 from the base 20. The sliding piece 330 is driven along a first direction that is parallel to the bottom cover 23, to move the fixing piece 31 from the first position to the second position, and along a second direction opposite to the first direction to move the fixing piece 31 from the second position to the first position.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A keyboard assembly comprising:
a base including a main body, and the main body defining a recess portion;
a keyboard received in the recess portion, and a first magnet being located on the keyboard; and
a fixing structure comprising a fixing piece, a second magnet, and a third magnet, the fixing piece configured to engage the recess portion, and the second magnet and the third magnet configured to attach to the fixing piece;
wherein the fixing piece is movable relative to the recess portion between a first position and a second position; when the fixing piece is located in the first position, the first magnet and the second magnet are attracted with each other, to secure the keyboard to the recess portion; when the fixing piece is located in the second position, the first magnet and the second magnet repel each other, to disengage the keyboard from the recess portion.

2. The keyboard assembly of claim 1, wherein the base further comprises a bottom cover secured to the main body, the fixing structure further comprises an operation portion engaged with the fixing piece and received in the cover, and the operation portion is slidable relative to the bottom cover to move the fixing piece.

3. The keyboard assembly of claim 2, wherein the operation portion comprises two latching hooks, the fixing piece comprises a connecting strip defining a fixing hole, and the latching hooks extend through the fixing hole to engage with the connecting strip.

4. The keyboard assembly of claim 3, wherein the fixing piece further comprises a protrusion portion located on the connecting strip, the bottom cover defines a through hole, and the protrusion portion is slidably engageable with the through hole.

5. The keyboard assembly of claim 4, wherein the operation portion further comprises a sliding piece connected to the two latching hooks, the bottom cover defines a receiving slot in communication with the through hole, and the sliding piece is slidably receivable in the receiving slot.

6. The keyboard assembly of claim 3, wherein the recess portion comprises a bottom wall defining two cutouts, and the second magnet and the third magnet are located in one of the two cutouts.

7. The keyboard assembly of claim 6, wherein a clipping hook extends from one edge of each of the two cutouts, the fixing piece further comprises two fixing tabs connected to the connecting strip, and the two fixing tabs are engageable with the clipping hooks.

8. The keyboard assembly of claim 7, wherein each of the two fixing tabs defines two fixing slots, and the second magnet and the second magnet are received in two fixing slots of one of the two fixing tabs.

9. A keyboard assembly comprising:
a base;
a keyboard received in the base, and two first magnets being located on the keyboard;
a fixing structure comprising a fixing piece; and
two absorbing members;
wherein each of the two absorbing members comprising a second magnet, the fixing piece being engaged with the base, and the second magnet being attached to the fixing piece; and
wherein each of the two first magnets is attracted with the second magnet of each of the two absorbing members, to secure the keyboard to the base, and the fixing piece is movable to disengage each of the two first magnets from the second magnet.

10. The keyboard assembly of claim 9, wherein each of the two absorbing members further comprises a third magnet attached to the fixing piece, and the fixing piece is movable to repel each of the two first magnets with the third magnet.

11. The keyboard assembly of claim 10, wherein the base comprises a main body defining a recess portion, the keyboard is received in the recess portion, and the fixing piece is engaged with the recess portion.

12. The keyboard assembly of claim 11, wherein the base further comprises a bottom cover secured to the main body, the fixing structure further comprises an operation portion engaged with the fixing piece and received in the cover, and the operation portion is slidable relative to the bottom cover to move the fixing piece.

13. The keyboard assembly of claim 12, wherein the operation portion comprises two latching hooks, the fixing piece comprises a connecting strip defining a fixing hole, and the latching hooks extend through the fixing hole to be engageable with the connecting strip.

14. The keyboard assembly of claim 13, wherein the fixing piece further comprises a protrusion portion located on the connecting strip, the bottom cover defines a through hole, and the protrusion portion is slidably engageable in the through hole.

15. The keyboard assembly of claim 14, wherein the operation portion further comprises a sliding piece connected to the two latching hooks, the bottom cover defines a receiving slot in communication with the through hole, and the sliding piece is slidably receivable in the receiving slot.

16. The keyboard assembly of claim 13, wherein the recess portion comprises a bottom wall defining two cutouts, and each of the two absorbing members is located in each of the two cutouts.

17. The keyboard assembly of claim 16, wherein a clipping hook extends from one edge of each of the two cutouts, the fixing piece further comprises two fixing tabs connected to the connecting strip, and the two fixing tabs are engageable with the clipping hooks.

18. The keyboard assembly of claim 17, wherein each of the two fixing tabs defines two fixing slots, and each of the two absorbing members is receivable in the two fixing slots of each of the two fixing tabs.
